(19) United States
(12) Patent Application Publication
(10) Pub. No.: US 2025/0165292 A1
(43) Pub. Date: May 22, 2025

(54) DATA PROCESSOR

(71) Applicant: Arm Limited, Cambridge (GB)

(72) Inventors: Dominic Hugo Symes, Cambridge (GB); Rune Holm, Oslo (NO); Thomas Patrik Andreas Olsson, Karlshamn (SE)

(21) Appl. No.: 18/512,615

(22) Filed: Nov. 17, 2023

(51) Int. Cl. G06F 9/50

(52) U.S. Cl. CPC G06F 9/5027

(57) ABSTRACT

The present disclosure relates to a data processor for processing data, comprising: a plurality of execution units to execute one or more operations; and a plurality of storage elements to store data for the one or more operations, the data processor being configured to process at least one task, each task to be executed in the form of a directed acyclic graph of operations, wherein each of the operations maps to a corresponding execution unit and each connection between operations in the acyclic graph maps to a corresponding storage element, the data processor further comprising: a plurality of counters; and a control module to control the plurality of counters to: in a first mode, count an operation cycle number associated with each operation of the at least one task, the operation cycle number of an operation being a number of cycles required to complete the operation; and in a second mode, count a unit cycle number associated with one or more execution units, the unit cycle number of an execution unit being an accumulative number of cycles when the execution unit is occupied in use during execution of the at least one task.

### FIELD

The present technology relates to methods, processors, and non-transitory computer-readable storage media for processing data by an operation set, such as neural network processing operations and graphics processing operations.

### BACKGROUND

Some data processing techniques, such as neural network processing and graphics processing, involve the processing and generation of considerable amounts of data using operations that may be executed on the same hardware execution units. Additionally, some data processing techniques may issue data through operations to multiple sets of execution units depending on the readiness of the data, readiness of the multiple sets of execution units and availability of storage. In these scenarios, a processor performance may be improved using architecture capable of arbitrating and prioritizing amongst these operations to make efficient progress through the processing.

There is, therefore, scope for improving implementation of such architecture and/or the architecture itself.

### SUMMARY

An aspect of the present technology provides a data processor for processing data, comprising: a plurality of execution units to execute one or more operations; and a plurality of storage elements to store data for the one or more operations, the data processor being configured to process at least one task, each task to be executed in the form of a graph of operations, wherein each of the operations maps to a corresponding execution unit and each connection between operations in the graph maps to a corresponding storage element, the data processor further comprising: a plurality of counters; and a control module to control the plurality of counters to: in a first mode, count an operation cycle number associated with each operation of the at least one task, the operation cycle number of an operation being a number of cycles required to complete the operation; and in a second mode, count a unit cycle number associated with one or more execution units, the unit cycle number of an execution unit being an accumulative number of cycles when the execution unit is occupied during execution of the at least one task.

Another aspect of the present technology provides a computer-implemented method of processing data in a data processor, the data processor comprising a plurality of execution units, a plurality of storage elements, a plurality of counters, and a control module, the data processor being configured to process at least one task, each task to be executed in the form of a graph of operations, wherein each of the operations maps to a corresponding execution unit and each connection between operations in the graph maps to a corresponding storage element, the method comprising: controlling, by the control module, the plurality of counters to: in a first mode, count an operation cycle number associated with each operation of the at least one task, the operation cycle number of an operation being a number of cycles required to complete the operation; and in a second mode, count a unit cycle number associated with one or more execution units, the unit cycle number of an execution unit being an accumulative number of cycles when the execution unit is occupied during execution of the at least one task.

A data processor according to embodiments of the present technology additionally comprises a plurality of counters and a control module to control the plurality of counters. As stated above, there are instances when more than one operation may execute on the same execution unit. In order to assess the performance of each operation, it may be desirable to determine an amount of time spent (e.g. a number of cycles) to complete each operation irrespective of the execution unit on which the operation executes. In other words, where there is a complete or partial overlap (running substantially simultaneously) between two (or more) operations executing on the same execution unit, the amount of time or number of cycles when both operations are running on the execution unit at the same time should be counted against each operation, i.e. counted twice. Thus, in a first mode, the control module controls the plurality of counters to count an operation cycle number associated with each operation of one or more tasks, wherein the operation cycle number of an operation is a number of cycles required to complete the operation. Through obtaining an operation cycle number against each operation, it is possible to assess the performance of each operation. In doing so, the graph of operations (or a part thereof) may be reprogrammed and/or refined to improve its performance e.g. by reassigning certain sub-optimal operations to other execution units or allocating or diverting additional resources to the sub-optimal operations to reduce an amount of time required to complete the sub-optimal operations. It may also be desirable to determine an amount of time spent (e.g. a number of cycles) when an execution unit is occupied, either by execution of one or more operations or by idling due to insufficient input data or insufficient output storage for the one or more operations executing thereon. In this case, it is of lesser or no concern the specific task (or operation) for which an execution unit is being used, but simply whether the execution unit is occupied by any tasks or operations. In other words, where there is a complete or partial overlap between two (or more) operations executing on the same execution unit (each operation associated with the same task or a different task) the amount of time or number of cycles when both operations are running on the execution unit at the same time should only be counted once as this value represents a time when the execution unit is in use or occupied. Thus, in a second mode, the control module controls the plurality of counters to count a unit cycle number associated with one or more execution units, wherein the unit cycle number of an execution unit is an accumulative number of cycles when the execution unit is occupied during execution of one or more tasks. Through obtaining a unit cycle number associated with individual execution units, it is possible to assess the performance of each execution unit. In doing so, the processor architecture (e.g. individual hardware units) and/or implementation of the architecture (e.g. compiler) may be reconfigured to improve the performance e.g. of the processor and/or the compiler, such as by reassigning the relationship between certain sub-optimal execution unit pairs or allocating or diverting additional resources (e.g. storage resources or processing resources) to the sub-optimal execution unit pairs to reduce an amount of idle time. Herein, the control module may be implemented as a dedicated hardware unit configured to perform the control function of switching between the first and second modes, or, preferably, the control module may be implemented as a software module that builds or constructs one or more control registers or data structures to facilitate switching between the first and second modes, or switching one or more counters off.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows an exemplary graph of operations in which sections are interconnected by a series of pipes;

FIG. 2 shows schematically an exemplary data processing system according to an embodiment;

FIG. 3 shows schematically an exemplary neural engine;

FIG. 4 illustrates exemplary modes of operations of a plurality of counters according to an embodiment;

FIG. 5 shows a flow chart of an exemplary data processing method; and

FIG. 6 shows a flow chart of an exemplary data processing method according to an embodiment.

### DETAILED DESCRIPTION

Examples herein relate to computer architecture systems, which include a memory unit and a handling unit together with methods of arbitration and prioritization carried out by the memory unit and the handling unit. In some embodiments, the memory unit may be a Dynamic Memory Access (DMA) circuit associated with a processor that is configured to perform neural network processing or graphics processing. In some embodiments, the handling unit may be a Traversal Synchronization Unit (TSU) that is operable to distribute processing tasks to be performed on execution units of a neural engine or on a shader core of a graphics processor.

Embodiments of the present technology include a neural engine comprising the memory unit and the handling unit. Accordingly, in embodiments the neural engine generally comprises a plurality of execution units, and a Neural Engine Descriptor (NED) describes operations and memory calls that the execution units produce or consume. Herein, the term “sections” refers to operations to perform and the term “pipes” refers to an array of storage units (storage elements) that are the input or the output to the section operations.

The NED is executed for a given multi-dimensional operation-space or unit-of-work and iteratively traverses the operation-space by dividing it into sub-units known as blocks. Arbitration and priority of the blocks may be applied in both the memory unit and the handling unit.

In the memory unit, which may be a dynamic memory access circuit, the circuit accepts multiple different blocks from a handling unit and applies a priority scheme on a transaction level to each block that requires submission of cache line transactions. Each cache line represents one transaction and arbitration is applied across these cache lines.

In the handling unit, e.g. a Traversal Synchronization Unit (TSU), in the case of there being a plurality of sections that have all input and output buffers available, there exists a matrix of valid inputs for transform by the handling unit. The handling unit may arbitrate at a block level ahead of transform from operation space to section space and then issue units of work into blocks for processing by the memory unit depending on block identification and graph depth. A table may be populated to keep track on where the issuing of blocks is in operation space.

Examples herein generally relate to a data processor comprising a handling unit, a plurality of storage elements, and a plurality of execution units. The processor is configured to obtain, from storage, task data that describes a task to be executed in the form of a graph, e.g. a directed acyclic graph, of operations, wherein each of the operations maps to a corresponding execution unit of the processor, and each connection between operations in the graph maps to a corresponding storage element of the processor. The task data defines an operation space representing the dimensions of a multi-dimensional arrangement of the connected operations to be executed.

For each of a plurality of portions of the operation space, the processor is configured to transform the portion of the operation space to generate respective operation-specific local spaces for each of the plurality of the operations of the graph.

The processor is further configured to dispatch, to each of a plurality of the execution units associated with operations for which transformed local spaces have been generated, invocation data describing the operation-specific local space, and at least one of a source storage element and a destination storage element corresponding to a connection between the particular operation that the execution unit is to execute and a further adjacent operation in the graph to which the particular operation is connected.

The present disclosure relates to executing a graph, e.g. a directed acyclic graph, of operations (referred to as sections) connected by various connections (referred to as pipes). By providing the capability to operate upon a sequence of connected operations (sections) that can be defined within an operation space common to the sequence of operations, it is possible to ensure that all coordinates required by the operations within the operation space are reachable when executing that sequence of operations. For each execution of an operation (or portion of an operation), the operation space is transformed into a local section space for that operation.

Each operation (section) is linked by corresponding pipes to form a graph of operations. For each operation, source and destination pipes can be defined and, under the control of a handling unit, the execution of sections can be issued e.g. by issuing invocation data that defines the source and destination pipes for the operation. This execution of the graph of operation by respective execution units is therefore implicitly ordered by the dependencies on specific inputs to the operation. The result of this implicit ordering being a simplified orchestration of operations amongst the execution units of the processor. In other words, sections and their relationship to each other can be determined by their pipe usage (e.g. their producers or consumers).

In the present disclosure, transforming from an operation space ensures that for each possible operation there is a specific coordinate space referred to as section-space (or section-specific local space). For every operation, there may be a fixed function transform from their individual section-space to each of their input and output data (pipes); this may be different for multiple inputs/output. However, every operation is defined with its own independent section-space that is specific to that section (or operation) without needing to map onto the output of other operations.

Different operations having different types are chained together by defining the common operation-space for the whole graph (or chain of operations), and then defining transforms from the operation-space to each operation's individual section-space. Thus, each hardware unit only needs to understand their fixed-function transform from section-space to input/output spaces, without needing to understand the chain of operations preceding or succeeding it. For example, it is possible to chain additional operations in front of or after a convolution operation and stitch a wider variety of operations together, provided that the conditions of a valid operation space exist. Since all sections are iterating through the same operation-space in execution, blocks of data are aligned. For example, a first block from a memory read operation is the first block into the data processing operation, and this trickles through to the first block in the memory write operation. This is a simplification given that for some operations (reduction and broadcast operations) since the block may be grouped with data from other blocks to form a new merged block, but generally holds as a principle. Operation-space is typically mapped to a specific operation's space in the graph, with programmatic transforms provided for all other operations. Operations accessing pipes might have an additional transform to access data stored in pipes. For example, this may be a different transform for the different pipes: different for multiple inputs, different for outputs. This transform is defined in the nature of the operation and is fixed function.

In summary, an operation's section space may be mapped to input and/or output (they can be the same), or operation's section space might be mapped separately in which case a fixed function transform might be needed. In this way, the sections-and-pipes approach allows for more compartmentalized functionality in separate execution units. The execution units of the processor can therefore be implemented in a more simplified structure since there is no need to provide the capability in each execution unit to perform complex transforms on the front-end or output of the execution units. Instead, the transformation from operation space to section space (and therefore the management of compatibility and correct structuring of data between consecutive operations) is managed and issued centrally by a single handling unit based upon the dimensionality of a pre-defined operation space—e.g. by a descriptor that defines the operation space and the sections and pipes that form the graph.

Since the single transform unit can execute the transforms from operation to section-space, the processor is able to add support for additional operations in the future without the need for significant hardware modification to the execution units to allow additional operations to be chained in front of or in any place in a chain. This allows new functionality to be added easily. As an example: for a convolution operation, dynamic weights can be added easily by adding a data re-ordering unit or transform capable of transforming a tensor in an activation layout into a weight layout, which can be handled by a convolution engine. Attributes of operations such as padding around the edges of an input can also be implemented through the transform mechanism.

Moreover, many less-common operations can be broken down into smaller units of execution (e.g. by simpler fundamental operations from which more complex, or less-common, operations can be constructed). Iteration of more common operations can enable support for larger operations that cannot otherwise be accommodated within the constraints of the processor, rather than implementing native support within an execution unit. For example, for convolution operations with a stride value >1 can be implemented by breaking the kernel down into single element increments and iteratively invoking a convolution engine with a 1 element kernel, thus making larger strides supported. Similar examples exist for operations that require a dilation value >1. 3D convolution operations can similarly be implemented as iterative 2D convolution operations.

In some examples, the processor may be configured such that more than one operation in the graph of operations is mapped to the same executing unit of the processor, and more than one connection in the graph of operations is respectively mapped to a different portion of the same storage element.

In some examples, the processor may be configured such that each execution unit of the plurality of execution units of the processor is configured to perform a specific operation type, and the mapping between operations in the graph and the execution units is defined based upon compatibility of execution between the operation in the graph and the specific operation type of the execution unit.

As described herein, a section has various parameters that describe the specifics of an execution. Thus, an element may be defined as a structured definition of a pipe or section to describe each type of section and each type of pipe. In some examples, the task data for the processor may comprise an element-count value that indicates a count of the number of elements mapping to each execution unit, where each element corresponds to an instance of use of an execution unit in order to execute each operation in the graph. The task data may also comprise a pipe-count value indicating a count of the number of pipes needed to execute the task. The task data may further comprise, for each element in the graph, element configuration data defining data used to configure the particular execution unit when executing the operation. The element configuration data may comprise an offset value pointing to a location in memory of transform data indicating the transform to the portion of the operation space to be performed to generate respective operation-specific local spaces for each of the plurality of the operations of the graph.

In some examples, the task data may comprise transform program data defining a plurality of programs, each program comprising a sequence of instructions selected from a transform instruction set. The transform program data may be stored for each of a pre-determined set of transforms from which a particular transform is selected to transform the portion of the operation space to generate respective operation-specific local spaces for each of the plurality of the operations of the graph. The transform program data may be configured to perform the particular transform upon a plurality of values stored in boundary registers defining the operation space to generate new values in the boundary registers.

In some examples, the processor may be configured to iterate over the operation space in blocks, where the blocks are created according to a pre-determined block size.

### Execution of a Graph

Many data structures to be executed in a processor can be expressed as a graph such as a directed acyclic graph (DAG). Examples of such data structures include neural networks which can be represented as a directed acyclic graph of operations that wholly compose the operations required to execute a network (i.e. to execute the operations performed across the layers of a neural network). A directed acyclic graph is a data structure of operations (herein also referred to as “sections”) having directed connections therebetween that indicate a flow of operations such that those directed connections do not form a closed loop. The connections between operations (or sections) present in the graph of operations are herein also referred to as “pipes”. An acyclic graph may contain any number of divergent and convergent branches.

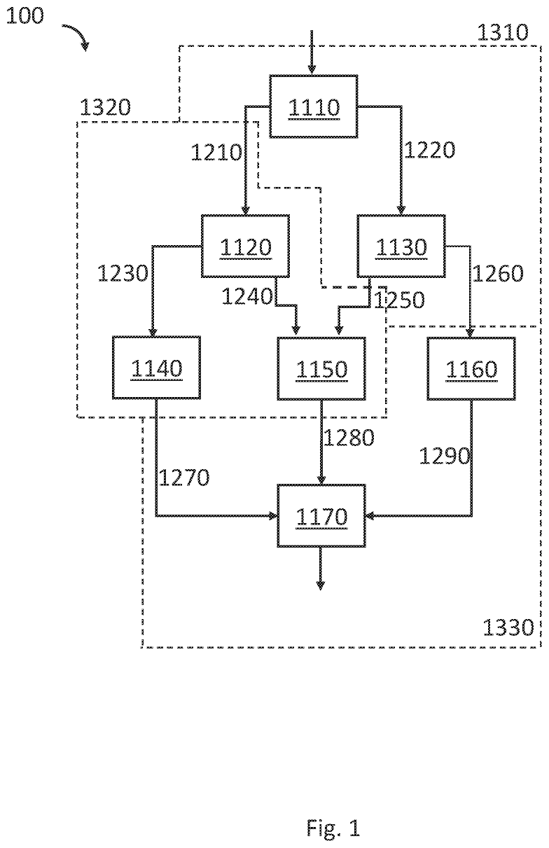

The operations performed when executing a neural network can be broken down into a sequence of operations forming a graph of operations in the form described in respect of FIG. 1.

FIG. 1 illustrates an exemplary graph 100 in which sections are interconnected by a series of pipes. Specifically, an initial section, section 1110 represents a point in the graph at which an operation, operation A, is to be performed when executing the graph. The output of section 1110, which is the result of performing operation A on the input to section 1110, can be provided to multiple subsequent sections in a branching manner. In the present example, the output of operation A at section 1100 is connected to two further sections, section 1120 and section 1130 at which respective operations B and Care to be performed. The connection between section 1110 and section 1120 are identified as a pipe with a unique identifier, pipe 1210. The connection between section 1110 and section 1130 are identified as a pipe with a different unique identifier, pipe 1220.

More generally, sections in the graph may receive multiple inputs, each from a respective different section in the graph via a respective different pipe. For example, section 1150 in FIG. 1 receives a first set of input data via pipe 1240 from section 1120 and a second set of input data via pipe 1250 from section 1130. Depending on the nature of the operation performed in a particular section and the dependencies of subsequent operations on the output of the operation, any number of input and output pipes may be connected to a particular section in the graph.

The graph may be represented by a number of sub-graphs each containing a subset of the sections in the graph. FIG. 1 illustrates an arrangement where the graph 100 is broken down into three sub-graphs 1310, 1320, and 1330, which are connected together to form the complete graph 100. For example, sub-graph 1310 contains sections 1110 and 1130 (as well as the corresponding pipes 1220 and 1260), sub-graph 1320 contains sections 1120, 1140, and 1150 (as well as corresponding pipes 1210, 1230, 1240 and 1250), and sub-graph 1330 contains sections 1160 and 1170 (as well as corresponding pipes 1270, 1280 and 1290).

The deconstruction of a graph 100 into sub-graphs is particularly useful when seeking to execute the graph as it enables separate execution of the sub-graphs to allow for parallelization of execution where there are no dependencies between sub-graphs. This can be particularly useful in a multi-processor environment where sub-graphs can be allocated for execution by different processors in the multi-processor environment. However, as shown in FIG. 1, sub-graph 1320 has a dependency on the execution of operation A and section 1110 and sub-graph 1330 has a dependency on sub-graph 1310. As such, execution of sub-graph 1330 may need to be stalled until sub-graph 1310 has been completed.

### Operation Space

When executing chains of operations, for example structured in a graph such as a directed acyclic graph, each section may represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is an extensive possible set of operators from which a neural network can be composed. The Applicant has recognized that the possible set of operations from which sections can be formed can be hard to manage when seeking to design hardware to enable the execution (also referred to as “acceleration”) of these operations-particularly when chained together. For example, enabling fixed-function operation of each possible type of operation can result in inefficient hardware by requiring support for obscure or complex operations (sections).

As a result, there are significant challenges in designing and building hardware capable of executing all types of neural networks created by the current machine learning toolsets. As a result, the Applicant has recognized that it is desirable to define a set of pre-determined low-level operations from which a broad range of possible higher-level operations that correspond with various machine learning tool sets can be built. One example of such a low-level set of operations is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUS, graphics processing units (GPUs) and custom hardware such as neural processing units/tensor processing units (NPUs/TPUs), with defined accuracy and compatibility constraints. Many operators from the common ML frameworks (TensorFlow, PyTorch, etc.) may then be expressible in TOSA.

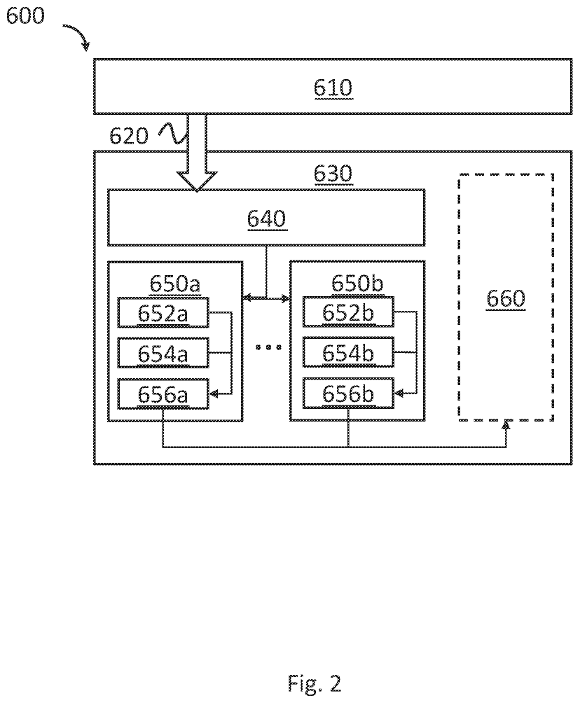

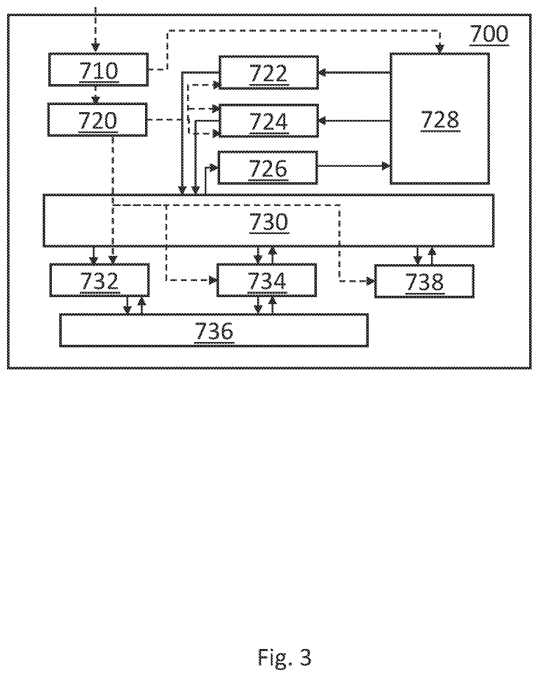

FIG. 3 is a schematic diagram of a neural engine 700, which in this example is used as a first processing module 652a, 652b in a data processing system 600 as shown in FIG. 2.

The neural engine 700 includes a command and control module 710. The command and control module 710 receives tasks from the command processing unit 640 (shown in FIG. 2), and also acts as an interface to storage external to the neural engine 700 (such as a local cache 656a, 656b and/or a L2 cache 660) which is arranged to store data to be processed by the neural engine 700, such as data representing a tensor, or data representing a stripe of a tensor. In the context of the present technology, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which, for example, may be a traversal synchronization unit (TSU). In the present example, each task corresponds to a stripe of a tensor which is to be operated upon in accordance with a sequence of operations according to at least a portion (e.g. a sub-graph) of the graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In the present example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In the present example, the operations are structured as a chain of operations representing a sequence of layers of the neural network. A block of data is allocated as an input to one of the operations by the handling unit 720.

The handling unit 720 coordinates the interaction of internal components of the neural engine 700, which, in the present example, include a weight fetch unit 722, an input reader 724, an output writer 726, a direct memory access (DMA) unit 728, a dot product unit (DPU) array 730, a vector engine 732, a transform unit 734, an accumulator buffer 736, and a storage 738, for processing of blocks of data. The data dependencies across the functional units are tracked by the handling unit 720. Processing is initiated by the handling unit 720 in a functional unit if all input blocks are available and space is available in the storage 738 of the neural engine 700. The storage 738 may be considered to be a shared buffer, in that various functional units of the neural engine 700 share access to the storage 738.

In the context of a graph representing the operations to be performed, each of the internal components that operates upon data can be considered to be one of two types of component. The first type of component is an execution unit (and is identified within the neural engine 700 as such) that maps to a section that performs a specific instance of an operation within the graph. Examples of execution units include the weight fetch unit 722, input reader 724, output writer 726, dot product unit array 730, vector engine 732, transform unit 734, each are configured to perform one or more pre-determined and fixed operations upon data that it receives. Each section can be uniquely identified with an identifier and each execution unit can also be uniquely identified.

Similarly, all physical storage elements within the neural engine (and in some instances portions of those physical storage elements) can be uniquely identified within the neural engine. The connections between sections in the graph representing the neural network are also referred to as pipes within the context of the graph. These pipes can be mapped to the uniquely identified physical storage elements in the neural engine. For example, the accumulator buffer 736 and storage 738 (and portions thereof) can each be regarded as a storage element that can act to store data for a pipe within the graph. The pipes act as connections between the sections (as executed by execution units) to enable a sequence of operations as defined in the graph to be chained together within the neural engine 700. Put another way, the logical dataflow of the graph can be mapped to the physical arrangement of execution units and storage elements within the neural engine 700. Under the control of the handling unit 720, execution can be scheduled on the execution units and data can be passed between the execution units via the storage elements in accordance with the mapping, such that the chained operations of a graph can be executed without needing to write data memory external to the neural engine 700 between executions. The handling unit 720 is configured to control and dispatch work representing performance of an operation of the graph on at least a portion of the data provided by a pipe.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly direct 1:1 mapping between pipes and storage elements is not necessary. In particular, a single execution unit may be configured at different instances in time to execute different instances of a convolution operation (e.g. first and second sections). Similarly, the input reader may be required to read data as part of different sections in the graph. The same can be said for storage elements and pipes.

Ordering of execution of the sections is implied by dependencies on inputs. A memory load operation has no data dependencies (unless it is a gather operation), so is implicitly early in the graph. The consumer of the pipe the memory read produces is implicitly after the memory read. A memory store operation is near the end of the graph, as it produces no pipes for other operations to consume. The sequence of execution of a chain of operations is therefore handled by the handling unit 720.

In some embodiments, sections such as InputRead and WeightFetch have no pipes and instead their data comes from external memory, such as an external cache or DRAM. By contrast, some sections, such as OutputWrite have no output pipes. In this case, their data is written to external memory.

For a section to run, it must have all the appropriate buffers available for its input source pipes. A section may produce a new buffer in its output destination pipe and so there must be space available in the pipe for this new buffer. In the case of a reduction operation (convolution, for example), a section may repeatedly read back and update the previous buffer it generated. As a result, for a reduction operation there is a distinction between the reduction operation having first generated the output buffer and the reduction having completed and the output buffer being fully available, due to this update process. In other words, there is a point in time at which the output buffer exists in the input pipe of a subsequent operation, but it is not yet ready to be consumed by the subsequent operation. The neural engine 700 is responsible for tracking all of these dependencies, in which buffers are tracked like FIFO entries, but with buffers only available for consumers when a producer has completed any sequence of reductions, and with buffers only freed up when all consumers have completed operations dependent on them.

Thus, the Applicant has recognised that, in order to assess the performance of the processor architecture and/or the compilation of a graph, e.g. a directed acyclic graph, of operations on the architecture, it may be useful to obtain performance data in respect of each operation (irrespective of the execution unit on which the operation executes) and/or in respect of each pair of dependent execution units, such that e.g. stalling due to data dependencies or inefficient use of execution units may be identified. Accordingly, it is desirable to provide methods and systems to generate and obtain performance data in respect of the sections-and-pipes architecture and the graph of operations implemented on the architecture so as to facilitate performance improvements.

The present technology thus provides systems and methods for assessing the performance for a sections-and-pipes processing architecture. In particular, the present approach seeks to (1) determine the runtime performance of a graph of operations e.g. to facilitate identification of overused or underperforming operators, and (2) determine the runtime performance of individual execution units e.g. to facilitate identification of dataflow bottlenecks between pairs of dependent execution units.

Examples described herein relate to a data processor for processing data, the data processor comprising a plurality of execution units to execute one or more operations and a plurality of storage elements to store data for the one or more operations. The data processor is configured to process at least one task, each task to be executed in the form of a graph, e.g. a directed acyclic graph, of operations, wherein each of the operations maps to a corresponding execution unit and each connection between operations in the graph maps to a corresponding storage element. The data processor further comprises a plurality of counters and a control module to control the plurality of counters. In a first mode, the plurality of counters is controlled to count an operation cycle number associated with each operation of the at least one task, the operation cycle number of an operation being a number of cycles required to complete the operation. In a second mode, the plurality of counters is controlled to count a unit cycle number associated with one or more execution units, the unit cycle number of an execution unit being an accumulative number of cycles when the execution unit is occupied during execution of the at least one task.

According to embodiments of the present technology, the data processor comprises a plurality of counters and a control module to control the plurality of counters. As stated above, there are instances when more than one operation may execute on the same execution unit. In order to assess the performance of each operation, it may be desirable to determine an amount of time spent (e.g. a number of cycles) to complete each operation irrespective of the execution unit on which the operation executes. In other words, where there is a complete or partial overlap (running substantially simultaneously) between two (or more) operations executing on the same execution unit, the amount of time or cycles when both operations are running on the execution unit at the same time should be counted against each operation, i.e. counted twice. Thus, in a first mode, the control module controls the plurality of counters to count an operation cycle number associated with each operation of one or more tasks, wherein the operation cycle number of an operation is a number of cycles required to complete the operation. Through obtaining an operation cycle number against each operation, it is possible to assess the performance of each operation. In doing so, the graph of operations (or a part thereof) may be reprogrammed and/or refined to improve its performance e.g. by reassigning certain sub-optimal operations to other execution units or allocating or diverting additional resources to the sub-optimal operations to reduce an amount of time required to complete the sub-optimal operations. It may also be desirable to determine an amount of time spent (e.g. a number of cycles) when an execution unit is occupied by execution of the one or more task. Herein, an execution is occupied when it is either actively executing one or more operations for one or more tasks, or waiting idle (stalled on an operation) due to insufficient input data for the one or more operations executing thereon or an output storage element being full (and therefore an operation executing thereon is unable to output data). In this case, it is of lesser or no concern for which task (and operation) an execution unit is being used, but simply whether the execution unit is occupied irrespective of tasks or operations. In other words, where there is a complete or partial overlap between two (or more) operations executing on the same execution unit (each operation may be associated with the same task or a different task), the amount of time or number of cycles when both operations are running on the execution unit at the same time should only be counted once as this value represents a time when the execution unit is in use or otherwise occupied. Thus, in a second mode, the control module controls the plurality of counters to count a unit cycle number associated with one or more execution units, wherein the unit cycle number of an execution unit is an accumulative number of cycles when the execution unit is occupied during execution of one or more tasks. Through obtaining a unit cycle number associated with individual execution units, it is possible to assess the performance of each execution unit. In doing so, the processor architecture (e.g. individual hardware units) and/or implementation of the architecture (e.g. compiler) may be reconfigured to improve the performance e.g. of the processor and/or the compiler, such as by reassigning the relationship between certain sub-optimal execution unit pairs or allocating or diverting additional resources (e.g. storage resources or processing resources) to the sub-optimal execution unit pairs to reduce an amount of idle time. Herein, the control module may be implemented as a dedicated hardware unit configured to perform the control function of switching between the first and second modes, or, preferably, the control module may be implemented as a software module that builds or constructs one or more control registers or data structures to facilitate switching between the first and second modes, or switching one or more counters off.

In some embodiments, the control module may be configured to, in the first mode, assign a set of counters from the plurality of counters to each task of the at least one task, wherein, for each task, each operation of the task is assigned with at least one counter from the corresponding set of counters to count the operation cycle number associated with the operation. In doing so, it is possible to independently track the number of cycles required for each operation of each task, irrespective of whether there are more than one operation executing on the same execution unit.

In some embodiments, the control module may be configured to, in the second mode, assign a set of counters from the plurality of counters to a pair of dependent execution units, wherein the pair of dependent execution units comprises a source execution unit that executes a first operation for the at least one task and a destination execution unit that executes a second operation for the at least one task by receiving input data from the source execution unit. In doing so, it is possible to track the performance of a pair of execution units with data dependency across overlapping tasks and irrespective of what operation each execution unit in the pair is performing.

In some embodiments, the set of counters may be configured to only count a cycle towards the unit cycle number of the pair of dependent execution units when at least one stall condition is met.

In some embodiments, the at least one stall condition may comprise: (a) the destination execution unit is idle on the second operation; (b) a destination connection to which the second operation outputs data is not full; (c) a source connection to which the first operation outputs data to the second operation is generated by the source execution unit; or (d) the source connection contains less than a block of data. Tracking the amount of time (number of cycles) when one or more of the stall conditions are met when a destination execution unit is unable to execute an operation even when it has the capacity to do so is useful for identifying data flow bottlenecks.

In some embodiments, the set of counters is configured to only count a cycle towards the unit cycle number of the pair of dependent execution units when all stall conditions are met.

In some embodiments, the plurality of execution units may comprise a first execution unit and the at least one task comprises a first task and a second task, the first execution unit may be configured to execute both a first operation associated with the first task and a second operation associated with the second task, and wherein the control module may be configured to, in the first mode, assign a first set of counters to the first task, at least one counter of the first set of counters being configured to count the operation cycle number against the first operation, and assign a second set of counters to the second task, at least one counter of the second set of counters being configured to count the operation cycle number against the second operation. In doing so, it is possible to separately track each operation even when there may be more than one operation executing on the same execution units.

Although during an overlapping cycle, two (or more) operations are executing on the same execution unit simultaneously, in order to assess the performance of each operation, the same cycle should be accounted for each operation separately. Thus, in some embodiments, in the first mode, for each overlapping cycle in which the first execution unit executes the first operation and the second operation substantially simultaneously, the first set of counters and the second set of counters may be configured to each separately count the overlapping cycle respectively against the first operation and the second operation.

In some embodiments, the plurality of execution units may comprise a first execution unit and the at least one task may comprise a first task and a second task, the first execution unit may be configured to execute both a first operation associated with the first task and a second operation associated with the second task, and wherein the control module may be configured to, in the second mode, assign a set of counters to the first execution unit to count the unit cycle number of the first execution unit when the first execution unit is occupied during execution of the first task and/or the second task. In doing so, it is possible to track the performance of a specific (or each) execution unit irrespective of tasks and/or operations.

In some embodiments, the first task and the second task may at least partially overlap, and the set of counters may be configured to, in the second mode, count the unit cycle number of the first execution unit against the first task to count a number of cycles when the first execution unit is executing the first operation or the second operation.

In some embodiments, the set of counters is configured to, in the second mode, reset upon completion of the first task, and to count the unit cycle number of the first execution unit against the second task to count a number of cycles when the first execution unit is executing the second operation. By counting against one task (in which the execution unit in question is involved) at a time, each overlapping cycle will only be counted once, and in doing so, the thus obtained cycle count is representative of the performance of the execution unit rather than individual operations.

Thus, embodiments of the present technology provide a data processor capable of generating performance statistics in two modes of operation.

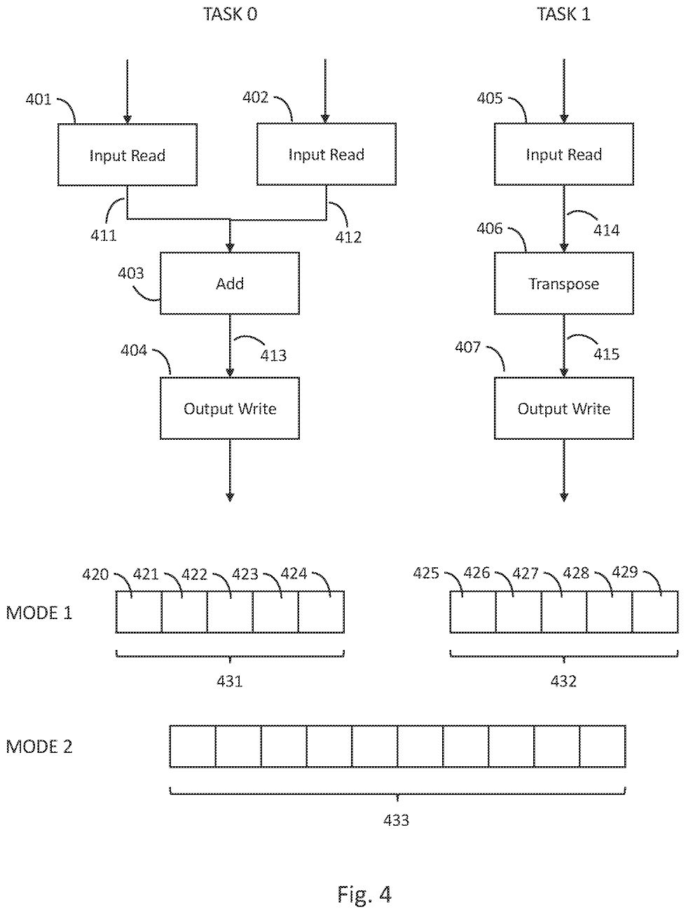

In an example, a graph of operations, such as graph 100 in FIG. 1, may be divided into multiple sub-graphs, each represents one of multiple tasks. Such an example is shown in FIG. 4, in which two tasks, e.g. TASK 0 and TASK 1, are shown. In TASK 0, the two “InputRead” operations 401, 402 executing on the same InputReader execution unit (not shown) each read data from memory and output to respective buffers pipes 411 and 412. The data in pipes 411 and 412 is input to operation “Add” 403 executing on a Vector Engine execution unit (not shown). The “Add” operation 403 outputs to buffer pipe 413 and the output data is written back to memory by “OutputWrite” operation 404 executed by an OutputWriter execution unit (not shown). In TASK 1, the “InputRead” operation 405 executing on the same InputReader execution unit each reads data from memory and output to buffer pipe 414. The data in pipe 414 is input to operation “Transpose” 406 executing on the Transform execution unit. The “Transpose” operation 406 outputs to buffer pipe 415 and the output data is written back to memory by “OutputWrite” operation 407 executed by the OutputWriter execution unit.

According to the embodiments, a plurality of counters 420-429 is provided to generate performance data on individual operations and tasks and/or individual execution units. In a first mode, the number of cycles associated with each operation (section) is tracked for each task. In particular, for each task, the number of cycles each operation (section) required to complete the task is counted. Optionally, the cycle number of an operation (section) may be mapped back to the execution unit that generated the operation; however, it is not essential as this mode is primarily concerned with the performance associated with individual operations of individual tasks to e.g. identify sub-optimal performance linked to a particular operation (section) of a particular task. Through assessing the performance of individual operations of individual tasks, it is possible to optimise sub-optimal portion(s) of a graph of operations such as by reprogramming the graph and/or changing the precision for one or more tasks, etc.

It can be seen that, in order to account for each operation associated with each task, cycles in which more than one operation overlap (cycles in which multiple operations executing simultaneously on the same execution unit) should be counted against each operation. Therefore, overlapping cycles on the same execution unit will need to be counted more than once, each against each operation involved. To facilitate the first mode, in the present example, two sets of counters, e.g. counter sets 431 and 432, are provided such that even (0) and odd (1) tasks may be counted by a separate independent set of counters so that tasks are counted correctly in case of overlapping. In particular, in the first mode, the counters 420-429 may be formed into sets of counters 431 and 432, each set associated with a task, e.g. respectively TASK 0 and TASK 1, and the counters of each set 431, 432 may be individually associated or identified with a section of the respective task (e.g. by means of a section number for each section). For example, counter 420 may be identified with section 401 and counts only for section 401, counter 421 may be identified with section 402 and counts only for section 402, and so on. Since mapping of section numbers may be different between different tasks, separate counters are preferably provided.

In a second mode, a set of counters 433 is provided to track the oldest incomplete task amongst multiple incomplete overlapping tasks, and the number of cycles associated with each execution unit when it is in use or otherwise occupied is tracked. Where tasks overlap, counting is performed against the oldest incomplete task. For example, if execution of TASK 0 and execution of TASK 1 at least partially overlap (e.g. the “InputRead” operations of TASK 0 and TASK 1 overlap), the set of counters 433 may be configured e.g. to first track the execution units involved in TASK 0, then when TASK 0 completes, cycle numbers associate with the execution units involved in TASK 0 are output by the set of counters 433 as TASK 1 continues to execute. The set of counters 433 is then reset and begins counting against TASK 1 until TASK 1 completes. Thus, in the second mode, cycles are counted no more than once since only one task out of any number of overlapping tasks is tracked by the set of counters at any given time.

In the second mode, the number of cycles while each execution unit is occupied is counted against one task at a time and then reset when the task completes, such that at each count is loosely associated with a task. In doing so, the amount of time a given execution unit is executing or otherwise occupied by execution of a task over the runtime of a graph of operations is obtained. In particular, one or more separate counters may be provided for each pair of execution units where a second execution unit (e.g. Vector Engine) is dependent on the output of a first execution unit (e.g. Input Read) such that the second execution unit may stall on the first execution unit e.g. while awaiting output from the first execution unit. For example, in TASK 0 of the present example, operation ADD executing on execution unit Vector Engine (VE) is dependent on operation InputRead on execution unit Input Reader (IR). For this pair, a dedicated counter may be provided for counting, e.g. when (1) VE source pipe (pipes 411, 412, 414) is produced by the IR; (2) VE source pipe (pipes 411, 412, 414) from which VE reads input data has no readable block; (3) VE is stalled; (4) VE destination pipe (pipes 413, 415) is not full.

The collected counter data represents the extent of stalling (idle) on a given execution unit due to its dependency on a preceding execution unit. The collected data associated with each pair of dependent execution units provides a measure or indication of the extent an execution unit is stalled on source data. In doing so, it is possible to identify sub-optimal performance linked to specific execution unit pairs. This information may be used for optimising the compiler of graphs, for example by allocating more resources (e.g. additional buffer capacity) to specific execution unit pairs (e.g. for source data and/or for output data) or implementing hardware upgrades e.g. by increasing processing or storage capacity for specific execution pairs.

While in the first mode cycles are counted against individual operation (section) even when multiple operations are running on the same execution unit simultaneously, in the second mode cycles are counted against individual execution units summed over overlapping tasks, thus each cycle is only counted once and the cycle number is not associated with specific tasks.

In the example of FIG. 4, the two “InputRead” operations of TASK 0 and the “InputRead” operation of TASK 1 all execute on the same “InputRead” execution unit, such that, in the first mode, if all three InputRead operations from TASK 0 and TASK 1 read respective input data during the same cycle, then that cycle is counted three times, each associated with each InputRead operation of the respective task. In the second mode, the input data read cycle is counted once only and is associated with the InputRead execution unit.

It is of course possible to operate both the first and second modes at the same time e.g. by providing separate counters for each of first and second mode such as a first plurality of counters 431, 432 local to each task to be used for the first mode and a second plurality of counters 433 associated with each execution unit pair involved. However, recognising that the two sets of performance data are generally used for different purposes (data from the first mode being used to assess the performance of a graph e.g. by a user to determine where time is spent within a machine learning model such that the graph may be fine-tuned, while data from the second mode being used e.g. by a compiler or hardware system designer to optimize the compilation process or to optimize its implementation to improve model performance), the present approach proposes an implementation in which a mode switch is enabled (e.g. through software-controlled registers or data structures) to switch data generation between the first and second modes. In doing so, the same set of counters may be configured for use in both modes to minimise the number of counters required. In such implementations, the same plurality of counters 420-429 are used and counter sets 431 and 432, and counter set 433 simply represents different arrangement of the same plurality of counters 420-429.

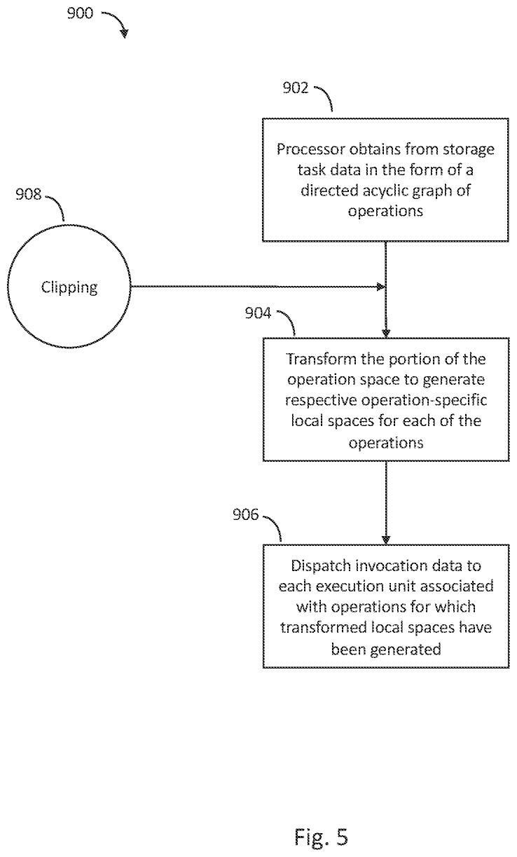

FIG. 5 shows a flow-chart of an example data processing method 900. The data processing method 900 is carried out on a processor configured for handling task data and comprising, for example, a handling unit, a plurality of storage elements, and a plurality of execution units. The task data includes a program comprising transform program data that describes a transform from operation space to section space (local space) for a corresponding section. At step 902, the processor obtains from storage the task data in the form of a graph of operations. Each of the operations maps to a corresponding execution unit of the processor and each connection between operations in the graph maps to a corresponding storage element of the processor. At step 904, for each corresponding portion of the operation space, the processor transforms the portion of the operation space to generate respective operation-specific local spaces for each of the plurality of the operations of the graph. At step 906, the processor dispatches to each of a plurality of the execution units associated with operations for which transformed local spaces have been generated, invocation data describing the operation-specific local space, and at least one of a source storage element and a destination storage element corresponding to a connection between the particular operation that the execution unit is to execute and a further adjacent operation in the graph to which the particular operation is connected. The processor may be further configured, where necessary, to perform clipping 908 on lower and upper bounds of a task and operation space before running the transform.

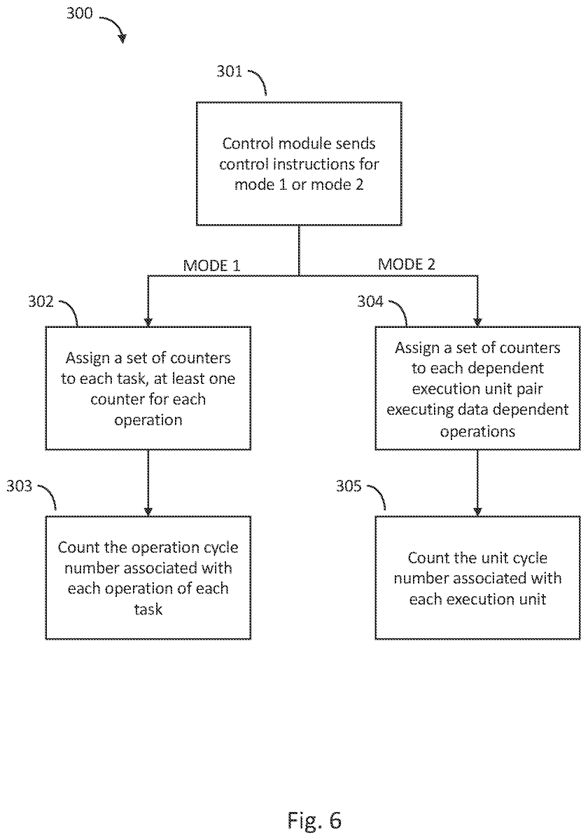

FIG. 6 shows a flow-chart of a method 300 of processing data in a data processor according to an embodiment. According to embodiments, the data processor comprises a plurality of execution units, a plurality of storage elements, a plurality of counters, and a control module, and the data processor is configured to process a plurality of tasks, each task to be executed in the form of a graph of operations, wherein each of the operations maps to a corresponding execution unit and each connection between operations in the graph maps to a corresponding storage element. The method beings at 301 at which the control module (e.g. implemented as a software module) controls the plurality of counters to switch to a first mode or a second mode.

In the first mode, at 302, the control module assigns a set of counters from the plurality of counters to each task of the plurality of tasks, wherein, for each task, each operation of the task is assigned with at least one counter from the corresponding set of counters. Then at 303, the at least one counter from the corresponding set of counters assigned to each operation counts an operation cycle number associated with the operation, where the operation cycle number of an operation is a number of cycles required to complete the operation.

In a second mode, at 304, the control module assigns a set of counters from the plurality of counters to a pair of dependent execution units, wherein the pair of dependent execution units comprises a source execution unit that executes a first operation for the at least one task and a destination execution unit that executes a second operation for the at least one task by receiving input data from the source execution unit. Then at 305, the set of counters assigned to each dependent execution unit pair counts a unit cycle number associated with the execution unit pair, where the unit cycle number of an execution unit is an accumulative number of cycles when the execution unit is occupied during execution of one or more tasks.

In some embodiments, the method may further comprise the set of counters only counting a cycle towards the unit cycle number of the pair of dependent execution units when at least one stall condition is met.

In some embodiments, the at least one stall condition may comprise: (a) the destination execution unit is idle on the second operation; (b) a destination connection to which the second operation outputs data is not full; (c) a source connection to which the first operation outputs data to the second operation is generated by the source execution unit; or (d) the source connection contains less than a block of data.

In some embodiments, the method may further comprise the set of counters only counting a cycle towards the unit cycle number of the pair of dependent execution units when all stall conditions are met.

In some embodiments, the plurality of execution units may comprise a first execution unit and the at least one task may comprise a first task and a second task, the first execution unit may be configured to execute both a first operation associated with the first task and a second operation associated with the second task, and the method may further comprise, in the first mode: assigning, by the control module, a first set of counters to the first task and configuring at least one counter of the first set of counters to count the operation cycle number against the first operation; and assigning, by the control module, a second set of counters to the second task and configuring at least one counter of the second set of counters to count the operation cycle number against the second operation.

In some embodiments, the method may further comprise, in the first mode, for each overlapping cycle in which the first execution unit substantially simultaneously executes the first operation and the second operation: counting, by the first set of counters the overlapping cycle against the first operation; and counting, by the second set of counters, the overlapping cycle against the second operation.

In some embodiments, the plurality of execution units may comprise a first execution unit and the at least one task may comprise a first task and a second task, the first execution unit may be configured to execute both a first operation associated with the first task and a second operation associated with the second task, and the method may further comprise, in the second mode: assigning, by the control module is configured to, a set of counters to the first execution unit to count the unit cycle number of the first execution unit when the first execution unit is occupied during execution of the first task and/or the second task.

In some embodiments, the first task and the second task may be at least partially overlap, and the method may further comprise, in the second mode: counting, by the set of counters, the unit cycle number of the first execution unit against the first task to count a number of cycles when the first execution unit is executing the first operation or the second operation. Optionally, upon completion of the first task, the method may comprise resetting the set of counters and counting the unit cycle number of the first execution unit against the second task to count a number of cycles when the first execution unit is executing the second operation.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

What is claimed is:

1. A data processor for processing data, comprising:
a plurality of execution units to execute one or more operations; and
a plurality of storage elements to store data for the one or more operations,
the data processor being configured to process at least one task, each task to be executed in the form of a graph of operations, wherein each of the operations maps to a corresponding execution unit and each connection between operations in the graph maps to a corresponding storage element,
the data processor further comprising:
a plurality of counters; and
a control module to control the plurality of counters to:
in a first mode, count an operation cycle number associated with each operation of the at least one task, the operation cycle number of an operation being a number of cycles required to complete the operation; and
in a second mode, count a unit cycle number associated with one or more execution units, the unit cycle number of an execution unit being an accumulative number of cycles when the execution unit is occupied during execution of the at least one task.

2. The data processor of claim 1, wherein the control module is configured to, in the first mode, assign a set of counters from the plurality of counters to each task of the at least one task, wherein, for each task, each operation of the task is assigned with at least one counter from the corresponding set of counters to count the operation cycle number associated with the operation.

3. The data processor of claim 1, wherein the control module is configured to, in the second mode, assign a set of counters from the plurality of counters to a pair of dependent execution units, wherein the pair of dependent execution units comprises a source execution unit that executes a first operation for the at least one task and a destination execution unit that executes a second operation for the at least one task by receiving input data from the source execution unit.

4. The data processor of claim 3, wherein the set of counters is configured to only count a cycle towards the unit cycle number of the pair of dependent execution units when at least one stall condition is met.

5. The data processor of claim 4, wherein the at least one stall condition comprises:
(a) the destination execution unit is idle on the second operation;
(b) a destination connection to which the second operation outputs data is not full;
(c) a source connection to which the first operation outputs data to the second operation is generated by the source execution unit; or
(d) the source connection contains less than a block of data.

6. The data processor of claim 5, wherein the set of counters is configured to only count a cycle towards the unit cycle number of the pair of dependent execution units when all stall conditions are met.

7. The data processor of claim 1, wherein the plurality of execution units comprises a first execution unit and the at least one task comprises a first task and a second task, the first execution unit being configured to execute both a first operation associated with the first task and a second operation associated with the second task, and wherein the control module is configured to, in the first mode, assign a first set of counters to the first task, at least one counter of the first set of counters being configured to count the operation cycle number against the first operation, and assign a second set of counters to the second task, at least one counter of the second set of counters being configured to count the operation cycle number against the second operation.

8. The data processor of claim 7, wherein, in the first mode, for each overlapping cycle in which the first execution unit executes the first operation and the second operation substantially simultaneously, the first set of counters and the second set of counters are configured to each separately count the overlapping cycle respectively against the first operation and the second operation.

9. The data processor of claim 1, wherein the plurality of execution units comprise a first execution unit and the at least one task comprises a first task and a second task, the first execution unit being configured to execute both a first operation associated with the first task and a second operation associated with the second task, and wherein the control module is configured to, in the second mode, assign a set of counters to the first execution unit to count the unit cycle number of the first execution unit when the first execution unit is occupied during execution of the first task and/or the second task.

10. The data processor of claim 9, wherein the first task and the second task at least partially overlap, and the set of counters is configured to, in the second mode, count the unit cycle number of the first execution unit against the first task to count a number of cycles when the first execution unit is executing the first operation or the second operation.

11. The data processor of claim 10, wherein the set of counters is configured to, in the second mode, reset upon completion of the first task, and to count the unit cycle number of the first execution unit against the second task to count a number of cycles when the first execution unit is executing the second operation.

12. A computer-implemented method of processing data in a data processor, the data processor comprising a plurality of execution units, a plurality of storage elements, a plurality of counters, and a control module, the data processor being configured to process at least one task, each task to be executed in the form of a graph of operations, wherein each of the operations maps to a corresponding execution unit and each connection between operations in the graph maps to a corresponding storage element, the method comprising:
controlling, by the control module, the plurality of counters to:
in a first mode, count an operation cycle number associated with each operation of the at least one task, the operation cycle number of an operation being a number of cycles required to complete the operation; and
in a second mode, count a unit cycle number associated with one or more execution units, the unit cycle number of an execution unit being an accumulative number of cycles when the execution unit is occupied during execution of the at least one task.

13. The method of claim 12, further comprising:
assigning, by the control module, in the first mode, a set of counters from the plurality of counters to each task of the at least one task, wherein, for each task, each operation of the task is assigned with at least one counter from the corresponding set of counters to count the operation cycle number associated with the operation; and
assigning, by the control module, in the second mode, a set of counters from the plurality of counters to a pair of dependent execution units, wherein the pair of dependent execution units comprises a source execution unit that executes a first operation for the at least one task and a destination execution unit that executes a second operation for the at least one task by receiving input data from the source execution unit.

14. The method of claim 13, further comprising the set of counters only counting a cycle towards the unit cycle number of the pair of dependent execution units when at least one stall condition is met.

15. The method of claim 14, wherein the at least one stall condition comprises:
(a) the destination execution unit is idle on the second operation;
(b) a destination connection to which the second operation outputs data is not full;
(c) a source connection to which the first operation outputs data to the second operation is generated by the source execution unit; or
(d) the source connection contains less than a block of data.

16. The method of claim 15, further comprising the set of counters only counting a cycle towards the unit cycle number of the pair of dependent execution units when all stall conditions are met.

17. The method of claim 12, wherein the plurality of execution units comprises a first execution unit and the at least one task comprises a first task and a second task, the first execution unit being configured to execute both a first operation associated with the first task and a second operation associated with the second task, and the method further comprises, in the first mode:
assigning, by the control module, a first set of counters to the first task and configuring at least one counter of the first set of counters to count the operation cycle number against the first operation; and
assigning, by the control module, a second set of counters to the second task and configuring at least one counter of the second set of counters to count the operation cycle number against the second operation.

18. The method of claim 17, further comprising, in the first mode, for each overlapping cycle in which the first execution unit substantially simultaneously executes the first operation and the second operation:
counting, by the first set of counters the overlapping cycle against the first operation; and
counting, by the second set of counters, the overlapping cycle against the second operation.

19. The method of claim 12, wherein the plurality of execution units comprises a first execution unit and the at least one task comprises a first task and a second task, the first execution unit being configured to execute both a first operation associated with the first task and a second operation associated with the second task, and the method further comprises, in the second mode:
assigning, by the control module is configured to, a set of counters to the first execution unit to count the unit cycle number of the first execution unit when the first execution unit is occupied during execution of the first task and/or the second task.

20. The method of claim 19, wherein the first task and the second task at least partially overlap, and the method further comprises, in the second mode:
counting, by the set of counters, the unit cycle number of the first execution unit against the first task to count a number of cycles when the first execution unit is executing the first operation or the second operation; and
optionally, upon completion of the first task, resetting the set of counters and counting the unit cycle number of the first execution unit against the second task to count a number of cycles when the first execution unit is executing the second operation.
